(19) United States
(12) Patent Application Publication
(10) Pub. No.: US 2012/0182190 A1
(43) Pub. Date: Jul. 19, 2012

(54) PORTABLE WIRELESS DEVICE

(75) Inventors: Tatsunori Yui, Ishikawa (JP); Kenya Nagano, Ishikawa (JP); Yoshio Koyanagi, Kanagawa (JP); Noriyoshi Satou, Kanagawa (JP)

(73) Assignee: PANASONIC CORPORATION, Osaka (JP)

(21) Appl. No.: 13/498,856

(22) PCT Filed: Oct. 13, 2010
(86) PCT No.: PCT/JP2010/006097

§ 371 Date: Mar. 28, 2012

(30) Foreign Application Priority Data
Oct. 14, 2009 (JP) 2009-236940

(51) Int. Cl. H01Q 1/24

(52) U.S. Cl. 343/702

(57) ABSTRACT

The mobile radio apparatus of the invention includes conductive housings 101 and 102, a circuit board 103 arranged between the conductive housings 101 and 102, a radio circuit 104 arranged on the circuit board 103, a resin 105 such as waterproof rubber packing arranged at a boundary between the conductive housings 101 and 102, a flexible board 106 arranged along a part of the resin 105, a conductor pattern 107 formed on the flexible board 106, a notch 108 formed in the conductive housings 101 and 102 of the periphery of the conductor pattern 107, a liquid crystal screen 109 arranged on the conductive housing 101, operation keys 110, an earpiece 111, and a mouthpiece 112.

### TECHNICAL FIELD

The present invention relates to mobile radio apparatus having a waterproof structure.

### BACKGROUND ART

A mobile radio apparatus with a waterproof structure generally includes a back side housing for receiving a circuit board and a front side housing with which this back side housing is covered, and is constructed by interposing frame-shaped waterproof rubber packing in the periphery of a boundary between this back side housing and the front side housing.

When an antenna is attached to the outside of the mobile radio apparatus with the waterproof structure, a waterproof structure of a power feeding portion for connecting the antenna to the circuit board of the inside of the housing becomes a problem and as a simple power feeding method, a configuration as shown in Patent Reference 1 is proposed. This configuration adopts a waterproof structure of sticking a strip-shaped waterproof seal on the periphery of a boundary between housings, and an antenna is arranged inside this waterproof seal and a terminal connected to a circuit board is formed on a surface of the housing and is electrically connected to the antenna.

On the other hand, when the antenna is received in a waterproof region of the inside of the housing, there is a problem that an antenna element approaches a circuit board earth potential (GND) and thereby antenna performance deteriorates in the case of the housing with a constant size, but as an improvement method, a configuration as shown in Patent Reference 2 is proposed. In this configuration, an antenna is buried in waterproof rubber packing and an antenna element is arranged in the outermost part of a waterproof region and is separated from a circuit board GND as much as possible and thereby, deterioration of antenna performance is reduced.

### PRIOR ART REFERENCE

### Patent Reference

Patent Reference 1: JP-A-7-99403
Patent Reference 2: Japanese Patent No. 3248250

### DISCLOSURE OF THE INVENTION

### Problems that the Invention is to Solve

However, when the housing is constructed of metal etc. for the purpose of improving the strength of the mobile radio apparatus, the configuration of arranging the antenna inside the waterproof seal as shown in Patent Reference 1 has a problem that antenna performance cannot be ensured since the antenna approaches the conductive housing. Also, the built-in antenna typified in Patent Reference 2 has a problem that antenna performance cannot be ensured since the antenna is covered with the conductive housing.

The invention has been implemented in view of the problems described above, and an object of the invention is to provide a configuration in which a power feeding structure is simple and deterioration of antenna performance is reduced in a mobile radio apparatus with a waterproof structure constructed of a conductive housing.

### Means for Solving the Problems

In order to solve such problems, a mobile radio apparatus of the invention includes a first conductive housing, a second conductive housing, a circuit board arranged between the first conductive housing and the second conductive housing, a radio circuit arranged on the circuit board, a flexible board arranged in the housing outside along a part of an outer periphery of a boundary between the first conductive housing and the second conductive housing, and an antenna element formed on the flexible board by a conductor pattern, and adopts a configuration in which the antenna element and the flexible board reach the inside of the first conductive housing and the second conductive housing and one end of the antenna element is connected to the radio circuit.

According to this configuration, the antenna element can be arranged in the outside of the conductive housings, and power can be fed from the radio circuit on the circuit board of the inside of the conductive housings to the antenna element. Also, a shape of the antenna element can be changed arbitrarily, so that flexibility of antenna design is high and deterioration of antenna performance can be reduced.

The mobile radio apparatus of the invention adopts a configuration in which a notch is put in the first conductive housing and the second conductive housing of a periphery of the antenna element and the antenna element is connected to the radio circuit through the notch part.

According to this configuration, a distance between the antenna element and the conductive housings can be increased, and power loss caused by influence of electromagnetic coupling due to metal proximity can be reduced.

The mobile radio apparatus of the invention includes a resin arranged at a part of a boundary between the first conductive housing and the second conductive housing, and adopts a configuration in which the flexible board is molded integrally to the resin and the antenna element and a part of the flexible board extend through the resin and one end of the antenna element is connected to the radio circuit.

According to this configuration, the flexible board is crimped by the resin and the degree of fixation can be increased. The mobile radio apparatus of the invention includes waterproof rubber packing arranged at a boundary between the first conductive housing and the second conductive housing, and adopts a configuration in which the flexible board is molded integrally to the waterproof rubber packing and the antenna element and the flexible board extend through the waterproof rubber packing and one end of the antenna element is connected to the radio circuit.

According to this configuration, in the mobile radio apparatus having the conductive housings and a waterproof structure, the antenna element can be arranged in the outside of the conductive housings, and power can be fed from the radio circuit on the circuit board of the inside of the conductive housings to the antenna element while maintaining waterproof properties.

The mobile radio apparatus of the invention adopts a configuration of including a resin case arranged so as to cover the flexible board.

According to this configuration, the flexible board and the antenna element arranged in the outside of the conductive housings can be protected.

### Advantage of the Invention

The mobile radio apparatus in the invention is configured as described above, and can implement the configuration in which a power feeding structure is simple and deterioration of antenna performance is reduced in the mobile radio apparatus with the waterproof structure constructed of the conductive housings.

### BRIEF DESCRIPTION OF THE DRAWINGS

FIG. 1 is an outline perspective view showing a configuration in a mobile radio apparatus of a first embodiment of the invention.

FIG. 2 is an internal arrangement diagram in the mobile radio apparatus of the first embodiment of the invention.

FIGS. 3(a) to 3(d) are side views showing notch shape examples of a conductive housing in the mobile radio apparatus of the first embodiment of the invention.

FIG. 4 is an enlarged view of a resin through part of a conductor pattern in the mobile radio apparatus of the first embodiment of the invention.

FIG. 5 is an enlarged perspective view of the resin through part of the conductor pattern in the mobile radio apparatus of the first embodiment of the invention.

FIG. 6 is an outline plan view showing a configuration in a mobile radio apparatus of a second embodiment of the invention.

FIG. 7 is an outline perspective view showing a configuration in a mobile radio apparatus of a third embodiment of the invention.

### MODE FOR CARRYING OUT THE INVENTION

Embodiments of the invention will hereinafter be described using the drawings.

### First Embodiment

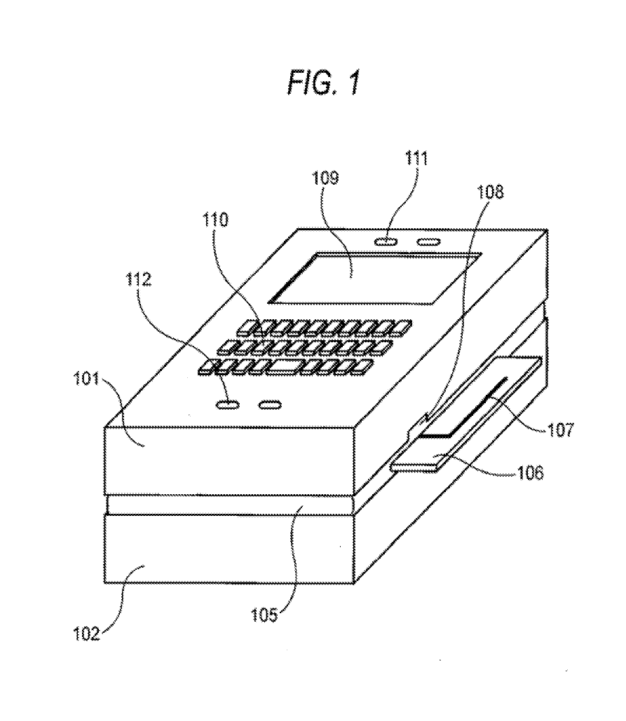

A configuration of a mobile radio apparatus in a first embodiment of the invention will be described with reference to FIGS. 1 to 5.

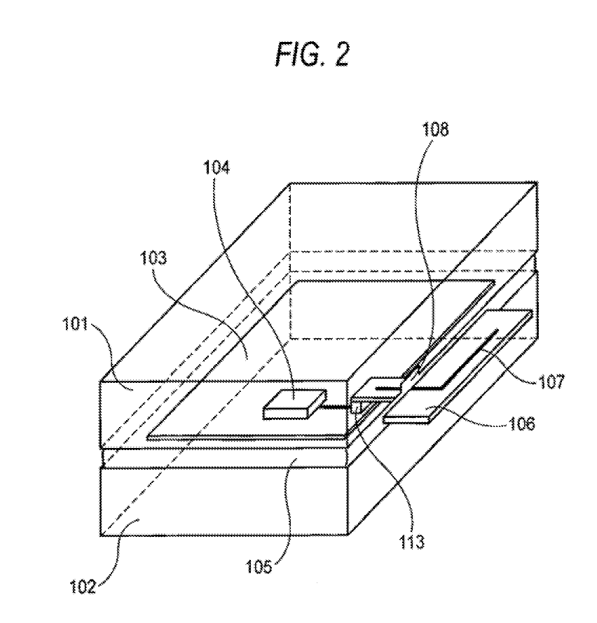

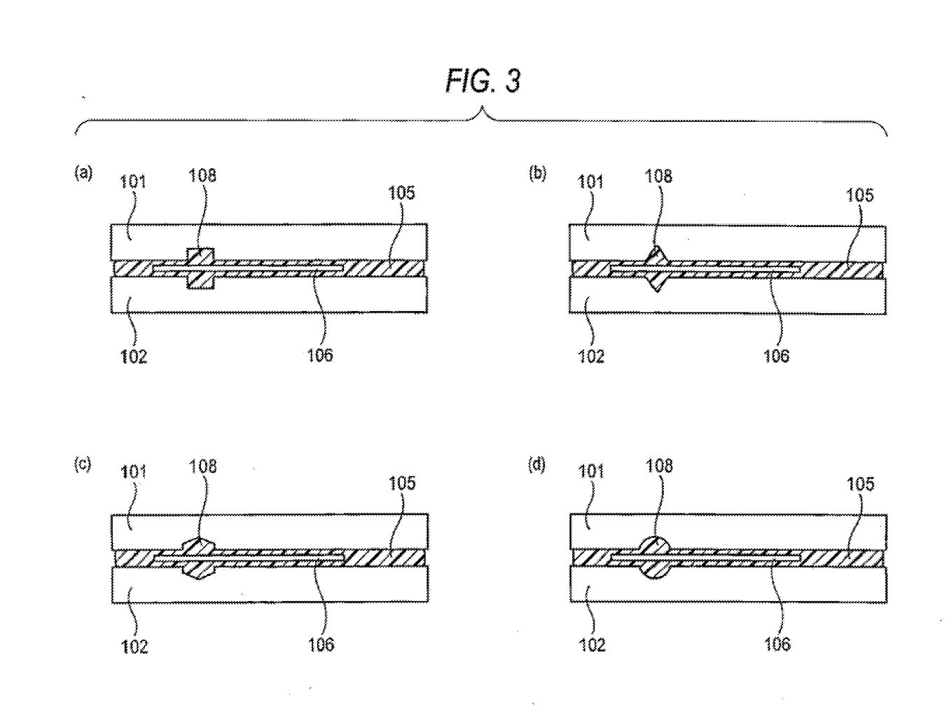

FIG. 1 shows an outline perspective view in the mobile radio apparatus of the first embodiment of the invention, and FIG. 2 shows an internal arrangement diagram in the mobile radio apparatus of the first embodiment of the invention, and FIGS. 3(a) to 3(d) show notch shapes of a conductive housing in the mobile radio apparatus of the first embodiment of the invention.

The mobile radio apparatus of the first embodiment of the invention includes conductive housings 101 and 102, a circuit board 103 arranged between the conductive housings 101 and 102, a radio circuit 104 arranged on the circuit board 103, a resin 105 arranged at a boundary between the conductive housings 101 and 102, a flexible board 106 arranged along a part of the resin 105, a conductor pattern 107 formed on the flexible board 106, a notch 108 formed in the conductive housings 101 and 102 of the periphery of the conductor pattern 107, a liquid crystal screen 109 arranged on the conductive housing 101, operation keys 110, an earpiece 111, and a mouthpiece 112. A part of the flexible board 106 and the conductor pattern 107 extend through the resin 105 of the portion of the notch 108 and reach the circuit board 103, and the conductor pattern 107 is electrically connected to the radio circuit 104 by a power feeding pin 113.

The conductive housings 101 and 102 are, for example, metal housings. Also, the conductor pattern 107 is, for example, a quarter-wave monopole antenna. Also, the resin 105 is, for example, waterproof rubber packing. When an operating frequency is set at 2 GHz, a length from the power feeding pin 113 of the conductor pattern 107 becomes about 40 mm and the conductor pattern 107 can be held by setting a size of the flexible board 106 arranged in the outside of the resin 105 at about 40 mm by 10 mm. The circuit board 103 is, for example, a multilayer dielectric board, and is used as a GND of an antenna element while various circuit components are mounted. By electrically connecting the GND of the circuit board 103 to the conductive housings 101 and 102 with large volume herein, antenna performance can be improved greatly. Also, by separating a distance between the conductive housings 101 and 102 and the antenna element constructed of the conductor pattern 107 by an about 1/50 wavelength or more, deterioration of antenna performance due to metal proximity can be reduced and high antenna performance can be achieved. Further, a distance between the conductor pattern 107 and the conductive housings 101 and 102 can be increased by forming the notch 108 in a place of intersection between the conductive housings 101 and 102 and the conductor pattern 107, so that power loss on electromagnetic coupling can be reduced and high antenna performance can be achieved. In addition, a shape of the notch 108 may be any shape as shown in FIGS. 3(a) to 3(d), and any shape can have substantially a similar effect when the nearest distance between the conductor pattern 107 and the conductive housings 101 and 102 is an about 1/100 wavelength.

By being configured thus, in a mobile terminal apparatus with a waterproof structure having the conductive housings, the antenna element with a simple power feeding structure can be arranged in the outside of the conductive housings and a configuration of reducing deterioration of antenna performance can be implemented.

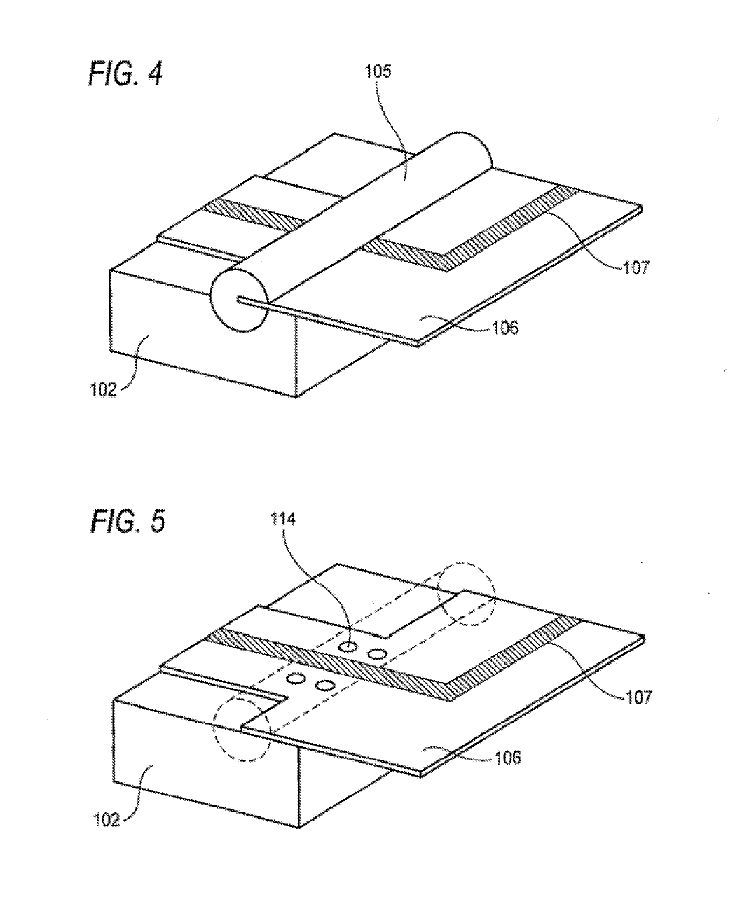

FIG. 4 is an enlarged view in a resin through part of the conductor pattern in the mobile radio apparatus of the first embodiment of the invention, and FIG. 5 is an enlarged perspective view of the resin through part of the conductor pattern in the mobile radio apparatus of the first embodiment of the invention.

A part of the flexible board 106 extends through the resin 105 and the other portion reaches the middle of the resin 105. Waterproof performance in this through part can be maintained by molding the flexible board 106 integrally to the resin 105. Also, by baring at least one or more holes 114 in the flexible board 106 positioned in this through part, the vertical resin 105 divided by the flexible board 106 is partially crimped and the degree of fixation can be increased.

By being configured as described above, even, when the housings have conductivity, the antenna element can be arranged in the outside of the housings, so that the antenna having geed performance can be constructed. Also, the shape of the conductor pattern can be changed arbitrarily, so that flexibility of antenna design is high and deterioration of antenna performance can be minimized. Also, the flexible board integrated with the waterproof rubber packing is arranged in the outside of the housings and the antenna element is formed on this flexible board by the conductor pattern and thereby, the mobile radio apparatus of the conductive housings having the antenna with a simple waterproof structure can be implemented.

In addition, in the present embodiment, the antenna element is described as the quarter-wave monopole antenna, but is not limited, to this antenna, and deterioration of antenna performance can be reduced by configuring the antenna in consideration of each component or a shape of the mobile radio apparatus.

### Second Embodiment

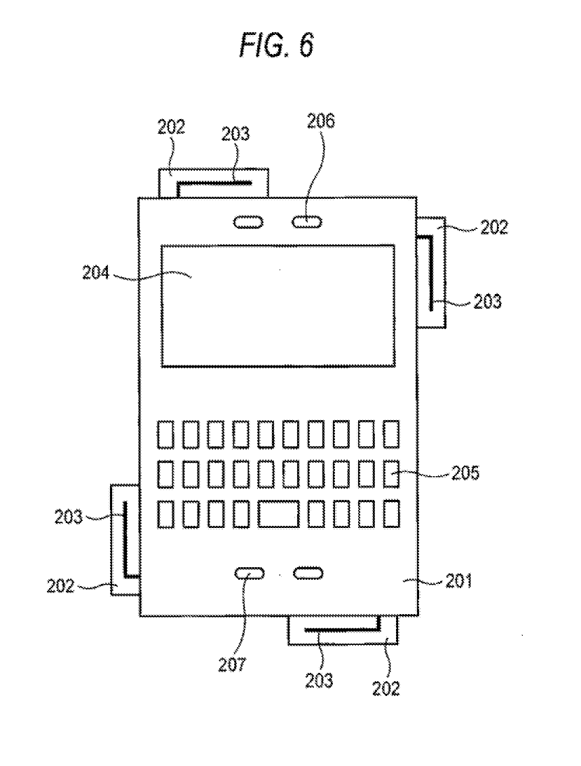

A configuration of a mobile radio apparatus in a second embodiment of the invention will be described with reference to FIG. 6.

FIG. 6 shows an outline plan view in the mobile radio apparatus of the second embodiment of the invention.

The mobile radio apparatus of the second embodiment of the invention is configured to arrange plural flexible boards 106 on which the conductor patterns 107 are formed in the mobile radio apparatus of the first embodiment.

Plural flexible boards 202 and conductor patterns 203 are configured to be arranged in four corners of the mobile radio apparatus and rotate directions of antenna elements formed by the respective conductor patterns 203 by 90 degrees as shown in FIG. 6.

By this configuration, in the mobile radio apparatus with a waterproof structure having conductive housings, plural antenna elements with a simple power feeding structure can be arranged in the outside of the conductive housings and while ensuring a distance between each of the antennas, principal polarization components of the adjacent antenna elements can be rotated by 90 degrees. Consequently, a polarization diversity effect can be obtained while reducing electromagnetic coupling between the antennas, and an antenna for MIMO transmission or sending and receiving diversity with good performance can be constructed.

In addition, the present embodiment is configured to arrange the four antenna elements in four corners of the mobile radio apparatus with the directions of the antenna elements rotated by 90 degrees, but is not limited to this, and when arrangement is antenna arrangement in which a distance between the antennas is a ¼ wavelength or more and the polarization diversity effect can be obtained, an antenna for MIMO transmission or sending and receiving diversity having performance equivalent to antenna performance in the present embodiment can be constructed.

Also, even when the distance between the antennas is a ¼ wavelength or less or the polarization diversity effect cannot be obtained, the antenna for MIMO transmission or sending and receiving diversity can be constructed as long as a configuration is an antenna configuration in which each of the antenna elements has good performance.

Also, the present embodiment is configured so that the number of antenna elements is four, but is not limited to this, and an antenna for MIMO transmission or sending and receiving diversity having the number of branches equal to the number of antenna elements can be constructed when the number of antenna elements is two or more.

### Third Embodiment

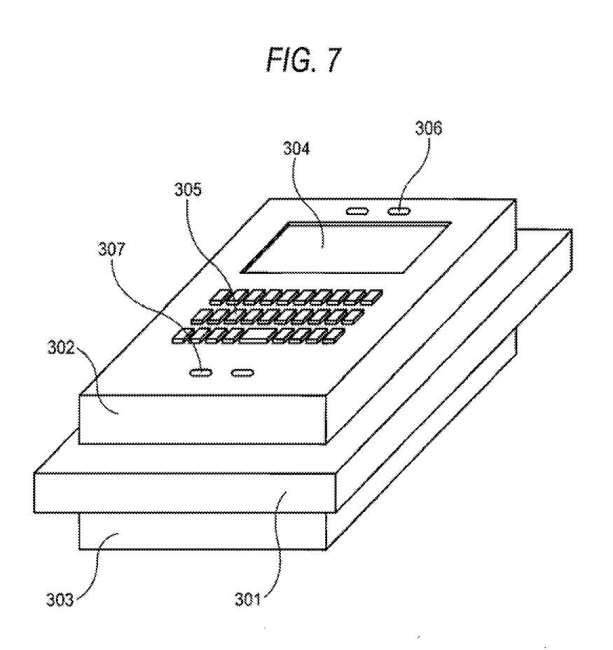

A configuration of a mobile radio apparatus in a third embodiment of the invention will be described with reference to FIG. 7.

FIG. 7 shows an outline perspective view the mobile radio apparatus of the third embodiment of the invention.

The mobile radio apparatus of the third embodiment of the invention is configured by arranging a resin case 301 in the periphery of the resin 105 so as to cover the flexible board 106 and the conductor pattern 107 in the mobile radio apparatus of the first embodiment of the invention.

By this configuration, an antenna element arranged in the outside of housings can be protected.

In addition, in the present embodiment, the resin case 301 is arranged so as to cover the whole periphery of the resin 105, but as long as the flexible board 106 and the conductor pattern 107 are configured to be covered with the resin case 301, an effect equivalent to that of the invention can be obtained even when the whole periphery of the resin 105 is not covered.

In addition, the invention intends to make various changes and applications by persons skilled in the art based on well-known techniques and the mention of the description without departing from the gist and scope of the invention, and the changes and applications are included in the scope of protection. Also, each of the components in the embodiments described above may be combined arbitrarily without departing from the gist of the invention.

The present application is based on Japanese patent application (patent application No. 2009-236940) filed on Oct. 14, 2009, and the contents of the patent application are hereby incorporated by reference.

### INDUSTRIAL APPLICABILITY

A mobile radio apparatus of the invention has an effect capable of implementing the mobile radio apparatus having an external antenna with a simple waterproof structure by arranging a flexible board integrated with waterproof rubber packing in the outside of a housing and forming an antenna element on this flexible board by a conductor pattern, and can be applied to, for example, a PC terminal, a fixed radio apparatus or a mobile radio apparatus having a waterproof structure:

### DESCRIPTION OF REFERENCE NUMERALS AND SIGNS

101 CONDUCTIVE HOUSING (FRONT SIDE)
102 CONDUCTIVE HOUSING (BACK SIDE)
103 CIRCUIT BOARD
104 RADIO CIRCUIT
105 RESIN
106 FLEXIBLE BOARD
107 CONDUCTOR PATTERN (ANTENNA ELEMENT)
108 NOTCH OF CONDUCTIVE HOUSING
109 LIQUID CRYSTAL SCREEN
110 OPERATION KEY
111 EARPIECE
112 MOUTHPIECE
113 POWER FEEDING PIN
114 HOLE FOR RESIN AND FLEXIBLE BOARD FIXING
201 CONDUCTIVE HOUSING (FRONT SIDE)
202 FLEXIBLE BOARD
203 CONDUCTOR PATTERN (ANTENNA ELEMENT)
204 LIQUID CRYSTAL SCREEN
205 OPERATION KEY
206 EARPIECE
207 MOUTHPIECE
301 RESIN CASE
302 CONDUCTIVE HOUSING (FRONT SIDE)
303 CONDUCTIVE HOUSING (BACK SIDE)
304 LIQUID CRYSTAL SCREEN
305 OPERATION KEY
306 EARPIECE
307 MOUTHPIECE

1. A mobile radio apparatus, comprising:
a first conductive housing;
a second conductive housing;
a circuit board arranged between the first conductive housing and the second conductive housing;
a radio circuit arranged on the circuit board,
a resin arranged at a part of a boundary between the first conductive housing and the second conductive housing,
a flexible board which is molded integrally to the resin and is arranged in the housing outside along a part of an outer periphery of a boundary between the first conductive housing and the second conductive housing, and
an antenna element formed on the flexible board by a conductor pattern;
wherein the antenna element and a part of the flexible board reach the inside of the first conductive housing and the second conductive housing and a notch is put in the first conductive housing and the second conductive housing in a periphery of the antenna element and the antenna element is connected to the radio circuit through the notch.

2.-3. (canceled)

4. The mobile radio apparatus as claimed in claim 1, wherein the resin is made of waterproof rubber packing.

5. The mobile radio apparatus as in claim 1, further comprising a resin case arranged so as to cover the flexible board.
